(19) United States
(12) Patent Application Publication
(10) Pub. No.: US 2025/0021824 A1
(43) Pub. Date: Jan. 16, 2025

(54) IMAGE TRAINING DEVICE AND METHOD ROBUST TO IMAGE ADVERSARIAL ATTACK

(71) Applicant: IUCF-HYU (INDUSTRY-UNIVERSITY COOPERATION FOUNDATION HANYANG UNIVERSITY), Seoul (KR)

(72) Inventors: Ki-Seok CHUNG, Seoul (KR); Hyun-Tak LIM, Seoul (KR)

(21) Appl. No.: 18/700,261

(22) PCT Filed: Oct. 12, 2022
(86) PCT No.: PCT/KR2022/015326

§ 371 Date: Apr. 10, 2024

(30) Foreign Application Priority Data
Oct. 12, 2021 (KR) 10-2021-0134957

(51) Int. Cl. G06N 3/094; G06N 3/082; G06N 3/084

(52) U.S. Cl. CPC G06N 3/094; G06N 3/082; G06N 3/084

(57) ABSTRACT

Proposed is an image training device and method that are robust to an image adversarial attack. The image training device includes: a normal image training unit configured to set weights of a convolutional neural network and a fully connected (FC) neural network through learning about a normal image; an adversarial image gradient acquisition unit configured to input an image damaged by an adversarial attack into the trained convolutional neural network and acquire a loss gradient size caused by the image damaged by the adversarial attack for each filter of the convolutional neural network; a filter pruning unit configured to prune some filters of the convolutional neural network based on the loss gradient size for each filter; and a retraining unit configured to retrain a convolutional neural network and a FC neural network modified through the filter pruning using the normal image.

### TECHNICAL FIELD

The present invention relates to an image training device and method, and more particularly, to an image training device and method that are robust to image adversarial attacks.

### BACKGROUND ART

Recently, research on artificial intelligence using artificial neural networks such as deep learning networks and convolutional neural networks is being actively conducted. In particular, significant advancements are being made in image processing using convolutional neural networks, and image processing using artificial neural networks show superior performance compared to image processing using existing algorithms.

With the development of artificial neural networks, adversarial attacks that degrade the performance of artificial neural networks have emerged. An adversarial attack is an attack that causes an artificial neural network to malfunction by adding intentional noise to a neural network input target image.

Artificial neural networks can also be used in fields directly related to safety, such as autonomous driving and security, and in fields directly related to safety, malfunctions of artificial neural networks can cause serious damage.

In particular, artificial neural networks are widely used for image object classification and object recognition and also used to detect various abnormal diseases in the medical field. Adversarial attacks on images can have a serious impact on object recognition in these fields and can cause fatal problems in the medical field.

Various methods have been proposed to respond to adversarial attacks on artificial neural networks, but these methods have problems in that they require significant time and resources to train the neural network or do not provide adequate performance.

### DISCLOSURE

### Technical Problem

The present invention is directed to providing an image training device and method that can effectively respond to adversarial image attacks.

The present invention is also directed to providing an image training device and method robust to adversarial attacks through filter pruning in a convolutional neural network.

### Technical Solution

One aspect of the present invention provides an image training device that is robust to an image adversarial attack, which includes: a normal image training unit configured to set weights of a convolutional neural network and a fully connected (FC) neural network through learning about a normal image; an adversarial image gradient acquisition unit configured to input an image damaged by an adversarial attack into the trained convolutional neural network and acquire a loss gradient size caused by the image damaged by the adversarial attack for each filter of the convolutional neural network; a filter pruning unit configured to prune some filters of the convolutional neural network based on the loss gradient size for each filter; and a retraining unit configured to retrain a convolutional neural network and a FC neural network modified through the filter pruning using the normal image.

The adversarial image gradient acquisition unit may include a loss gradient calculation unit configured to input the image damaged by the adversarial attack to calculate loss gradients generated by backpropagating a loss between a feature value output from the FC neural network and a correct answer label; and a gradient size acquisition unit for each filter configured to acquire loss gradients for each filter of the convolution neural network and acquire sizes of the acquired loss gradients for each filter.

The gradient size acquisition unit for each filter may acquire gradient sizes for each filter by calculating an L2 norm of the gradients for each filter.

The filter pruning unit may prune filters whose gradient sizes are greater than or equal to a threshold value.

The threshold value may be set adaptively based on the gradient sizes of the filters.

The retraining unit may reset weights of the modified convolutional neural network by comparing feature values output through the modified convolutional neural network and the FC neural network with the correct answer label.

Another aspect of the present invention provides an image training method that is robust to an image adversarial attack, which includes operations of: (a) setting weights of a convolution neural network and a fully connected (FC) neural network through learning about a normal image; (b) inputting an image damaged by an adversarial attack into the trained convolutional neural network and acquiring a loss gradient size caused by the image damaged by the adversarial attack for each filter of the convolutional neural network; (c) pruning some filters of the convolutional neural network based on the loss gradient size for each filter; and (d) retraining a convolutional neural network and a FC neural network modified through the operation (c).

### Advantageous Effects

According to the present invention, there is an advantage of being able to efficiently respond to adversarial image attacks through filter pruning of a convolutional neural network.

### DESCRIPTION OF DRAWINGS

FIG. 1 is a diagram illustrating an example of an adversarial attack on an artificial neural network.

FIG. 2 is a diagram illustrating the structure of a neural network to which a training device and method according to an embodiment of the present invention are applied.

FIG. 3 is a block diagram illustrating the structure of a training device that is robust to image adversarial attacks according to an embodiment of the present invention.

FIG. 4 is a block diagram illustrating the structure of a normal image training unit according to an embodiment of the present invention.

FIG. 5 is a diagram illustrating the structure of an adversarial image gradient acquisition unit according to an embodiment of the present invention.

FIG. 6 is a diagram illustrating the concept of filter pruning according to an embodiment of the present invention.

FIG. 7 is a flowchart illustrating the overall flow of a training method for responding to image adversarial attacks according to an embodiment of the present invention.

### MODES OF THE INVENTION

In order to fully understand the present invention, the operational advantages of the present invention, and the objectives achieved by the embodiments of the present invention, reference should be made to the accompanying drawings illustrating exemplary embodiments of the present invention and the contents described therein.

Hereinafter, the present invention will be described in detail by explaining exemplary embodiments of the present invention with reference to the accompanying drawings. However, the present invention can be implemented in various different forms and is not limited to the exemplary embodiments described herein. In order to clearly describe the present invention, parts which may obscure the present invention may be omitted, and like reference numerals denote like components.

Throughout the specification, when a part is said to “include” a certain element, this does not mean that other elements are excluded, unless otherwise stated, but means that other elements can be further included. In addition, the terms “ . . . unit,” “ . . . er,” “module,” and “block” described in the specification refer to units for processing at least one function and operation and can be implemented by hardware or software or combinations thereof.

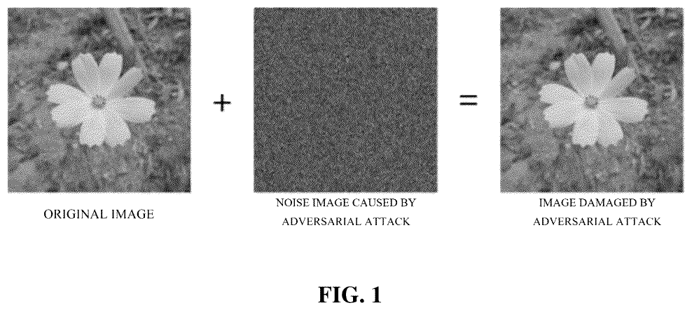

FIG. 1 is a diagram illustrating an example of an adversarial attack on an artificial neural network.

An adversarial attack in the artificial neural network is one artificial neural network attack that causes an artificial neural network learning model to malfunction by adding noise, which is difficult to distinguish with the human eye, to an image.

A representative adversarial attack is a fast gradient sign method (FGSM). FGSM can be defined as Equation 1 below.

$$η = ϵ sign ( {∇}_{x} J ( θ , x , y ) ) \qquad [ Equation 1 ]$$

In Equation 1 above, ε denotes a predetermined constant, x denotes an input image, y denotes a correct answer label of the input image, and θ denotes a parameter of a neural network.

Referring to FIG. 1, an original image, adversarial attack noise, and an image to which noise is added by the adversarial attack are each shown. Referring to FIG. 1, it can be seen that it is difficult to visually distinguish changes in the image although noise has been added by the adversarial attack.

The adversarial attack is performed by adding noise according to Equation 1 to the image through backpropagation when the artificial neural network is trained, and since it is difficult to visually identify the noise, it is very difficult to determine whether an adversarial attack has occurred.

An adversarial attack may cause a serious malfunction of the learning model, such that a learning model with an error rate of 1.6% for a Modified National Institute of Standards and Technology (MNIST) dataset results in an error rate of 99%.

In existing research, adversarial attacks were thought to be problems related to the linearity of artificial neural networks. According to research by the inventor of the present invention, the impact of malfunctions caused by adversarial attacks varies depending on the features of the image.

The features of an image are output through neural network calculations, and these features of an image may be divided into features that are robust to adversarial attacks and features that are not robust to adversarial attacks. The features of an image consist of a plurality of feature maps, and in a convolutional neural network (CNN), each feature map is obtained through the weight of a filter (convolution kernel) and a convolution operation on the input image.

The present invention proposes a training method that is robust to adversarial attacks by selecting a filter associated with a feature map that is not robust to adversarial attacks from among a plurality of filters constituting a CNN and removing the selected filter. Hereinafter, a learning structure of the present invention will be described in detail.

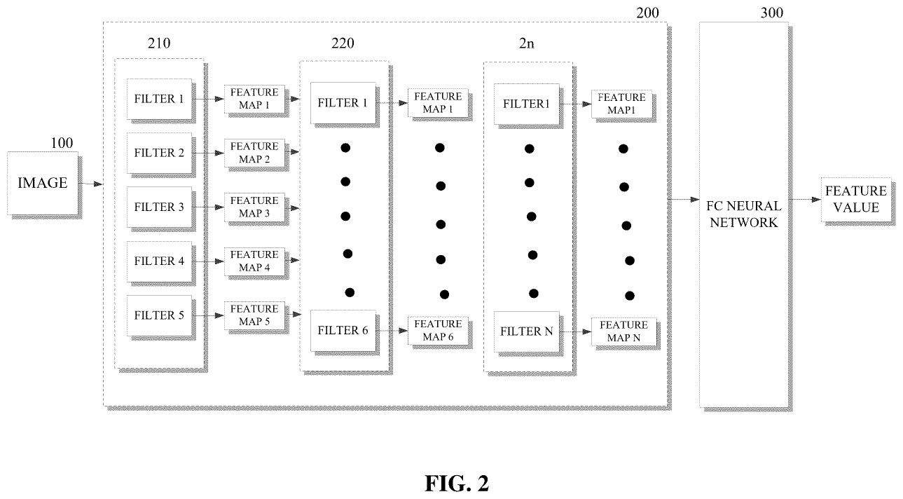

FIG. 2 is a diagram illustrating the structure of a neural network to which a training device and method according to an embodiment of the present invention are applied.

Referring to FIG. 2, a neural network applied to an image training device that is robust to adversarial attacks according to an embodiment of the present invention includes a convolutional neural network 200 and a fully connected (FC) neural network 300.

An input image 100 is input to the convolutional neural network 200, and the convolutional neural network 200 generates a feature map by performing a convolution operation on the input image 100 using a weight included in a filter.

According to an embodiment of the present invention, the convolutional neural network 200 may be composed of a plurality of layers 210, 220, . . . , and 2n.

The convolutional neural network 200 includes a filter for each layer and generates a feature map by independently performing a convolution operation for each layer.

For example, 5 filters are set in a first layer 210, and a convolution operation using a weight for each filter is performed to generate a feature map. Since 5 filters are set, 5 feature maps are generated in the first layer. The size of the filter and the size of the feature map are set in advance by a designer of the neural network, and the number of filters is also set in advance by the designer of the neural network.

The feature map output through the convolution operation in the first layer 210 is transferred to a second layer 220. In the example shown in FIG. 2, six filters are set in the second layer 220, and six feature maps are generated in the second layer.

In this way, the feature map output from a specific layer is input to the next layer, and this process continues up to the last layer, that is, an N-th layer 2n. The final feature map is output through the N-th layer 2n, and the number of final feature maps corresponds to the number of filters set in the N-th layer 2n.

The feature map output from the convolutional neural network 200 is input to the FC neural network 300. The FC neural network 300 outputs a feature value through performing an FC operation on the feature map. For example, the feature value may be a probability value of an object class desired to be recognized.

The FC neural network 300 is a widely known neural network and the computational structure of the FC neural network 300 is widely known, so detailed description thereof will be omitted.

The neural network with the structure shown in FIG. 2 is mainly used for object recognition, and when the image 100 is subjected to an adversarial attack, object recognition performance is significantly degraded.

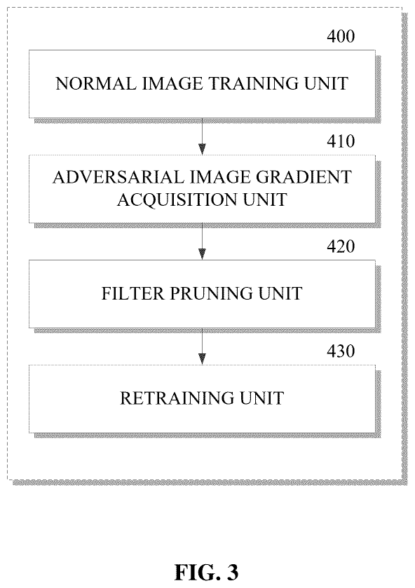

FIG. 3 is a block diagram illustrating the structure of a training device that is robust to image adversarial attacks according to an embodiment of the present invention.

Referring to FIG. 3, a training device that is robust to image adversarial attacks according to the embodiment of the present invention includes a normal image training unit 400, an adversarial image gradient acquisition unit 410, a filter pruning unit 420, and a retraining unit 430.

The normal image training unit 400 performs training by learning about the weights of the filter of the convolutional neural network 200 and the filter of the FC network 300 using a normal image. The normal image refers to an image that has not been damaged by an adversarial attack.

FIG. 4 is a block diagram illustrating the structure of a normal image training unit according to an embodiment of the present invention.

The normal image training unit 400 according to the embodiment of the present invention includes the convolutional neural network 200, the FC neural network 300, and a loss gradient backpropagation unit 402.

A normal image is input to the convolutional neural network 200, and the convolutional neural network 200 generates a feature map by performing a convolution operation on the normal image. As described above, the feature map is generated by applying the weight of a currently set filter to the normal image and performing a convolution operation. As described above, the convolutional neural network 200 may be composed of a plurality of layers, and a feature map is independently generated for each layer.

The FC neural network 300 performs an additional neural network operation on the feature map generated by the convolutional neural network 200 to generate probability information for N preset classes. Here, the class refers to an object to be recognized. For example, in the case of a network that desires to recognize a dog, a cat, an eagle, and a cow from images, the dog, cat, eagle, and cow correspond to each class.

The FC neural network 300 generates probability information for each class through a neural network operation and determines that a class with the highest probability is an object included in the input image. In the example described above, when the dog, cat, eagle, and cow are classes and the FC neural network 300 outputs the highest class probability value for the cat, the object included in the image is determined to be a cat.

The loss gradient backpropagation unit 402 compares the probability value for each class generated through the FC neural network 300 with a correct answer label, and backpropagates a gradient for a loss. For example, in a network that recognizes a dog, a cat, an eagle, and a cow, when an input image is a cat, the output of the FC neural network 300 ideally has a probability of 1 for a cat and 0 for other objects.

However, a neural network whose training has not been completed does not output such a correct answer, and the loss gradient backpropagation unit 402 backpropagates a gradient corresponding to a loss between the output of the FC neural network and the correct answer label to the FC neural network 300 and the convolutional neural network 200.

A gradient value is set in a direction to reduce the loss backpropagated by the loss gradient backpropagation unit 402, and the FC neural network 300 and the convolutional neural network 200 update the weights of filters based on the gradient value.

This updating of filter weights is performed repeatedly, and learning about a normal image may be performed repeatedly until the filter weight converges.

The adversarial image gradient acquisition unit 410 inputs an adversarial image damaged by an adversarial attack into the convolutional neural network 200 and the FC neural network 300, which have been trained on the normal image, and then acquires the loss gradient according to the neural network operation on the adversarial image.

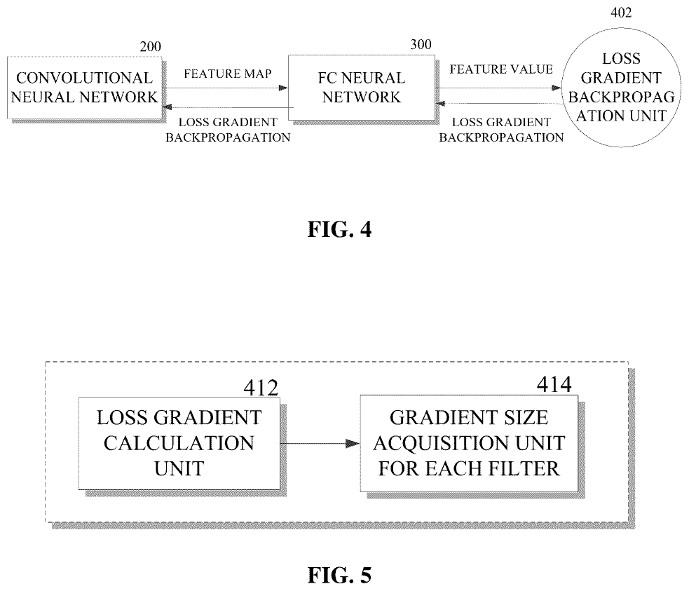

FIG. 5 is a diagram illustrating the structure of an adversarial image gradient acquisition unit according to an embodiment of the present invention.

Referring to FIG. 5, the adversarial image gradient acquisition unit 410 according to the embodiment of the present invention includes a loss gradient calculation unit 412 and a gradient size acquisition unit 414 for each filter.

The loss gradient calculation unit 412 acquires a loss gradient by comparing a class probability value output through the neural network operation of the convolutional neural network 200 and the FC neural network 300 with the value of the correct image.

The loss gradient size acquisition unit 414 for each filter acquires the size of the backpropagated loss gradient for each filter. According to an embodiment of the present invention, the size of the loss gradient of each filter may be acquired by calculating an L2 norm of the loss gradients of each filter. Of course, it will be obvious to those skilled in the art that size information can be acquired in various ways other than L2 norm.

The number of loss gradients propagated to a single filter corresponds to the number of weights in the filter. For example, when the size of a specific filter is 3×3, a total of 9 loss gradients are propagated to the filter. In this case, the loss gradient size acquisition unit 414 for each filter calculates the L2 norm for 9 loss gradients to acquire the size of the loss gradient of the corresponding filter.

A method of calculating the gradient size in the loss gradient size acquisition unit 414 for each filter through the L2 norm can be expressed as Equation 2 below.

$${L}_{2} = \sqrt{{\sum }_{i}^{n} {x}_{i}^{2}} = \sqrt{{x}_{1}^{2} + {x}_{2}^{2} + {x}_{3}^{2} + … + {x}_{n}^{2}} \qquad [ Equation 2 ]$$

In the above Equation, xi denotes gradients propagated to one filter, and when the number of weights and gradients of the filter is 9, n becomes 9.

The filter pruning unit 420 prunes some of the plurality of filters constituting the convolutional neural network 200 based on the acquired loss gradient size for each filter. Here, filter pruning means filter removal.

According to an embodiment of the present invention, when the loss gradient size of a specific filter among the plurality of filters is greater than or equal to a predetermined threshold value, the corresponding filter is pruned.

The neural network to which the image damaged by the adversarial attack is input is a neural network that has already been trained with the normal image. Therefore, when the normal image is input, the size of the loss gradient propagated to each filter will not be large. However, when an image damaged by the adversarial attack is input, the size of the loss gradient backpropagated to the specific filter may increase due to the adversarial attack. The filter with the large loss gradient size may act as a filter that generates a feature map that is vulnerable to an adversarial attack. The present invention is for removing a filter with a loss gradient size greater than or equal to a predetermined threshold value so that only feature maps that are robust to adversarial attacks may be generated.

Filter pruning by the filter pruning unit 420 is performed on all filters of each layer constituting the convolutional neural network.

At this time, the threshold value may be fixedly determined or determined adaptively by considering the size of loss gradients that occur when the adversarial image is input.

For example, when 30% of the filters of a specific layer are set to be pruned and 70% thereof are set to be maintained, after the loss gradient sizes of the filters of the corresponding layer are acquired, the threshold value of the loss gradient size for maintaining 70% of the filters may be set and then the filters may be pruned. Of course, alternatively, the threshold value may be set in advance, and the filter pruning unit 420 may operate to remove all filters with a loss gradient size less than or equal to the threshold value.

When the convolutional neural network is modified by removing the filters selected from the convolutional neural network by the filter pruning unit, the retraining unit 430 performs retraining on the modified convolutional neural network using the normal image. Since the selected filters have been removed, retraining is performed on the remaining filters. Training by the retraining unit 430 is performed in the same manner as training by the normal image training unit 400.

Since the filters that generate feature maps vulnerable to adversarial attacks have been pruned, the convolutional neural network 200 and FC neural network 300 retrained by the retraining unit 430 may robustly respond to the adversarial attack.

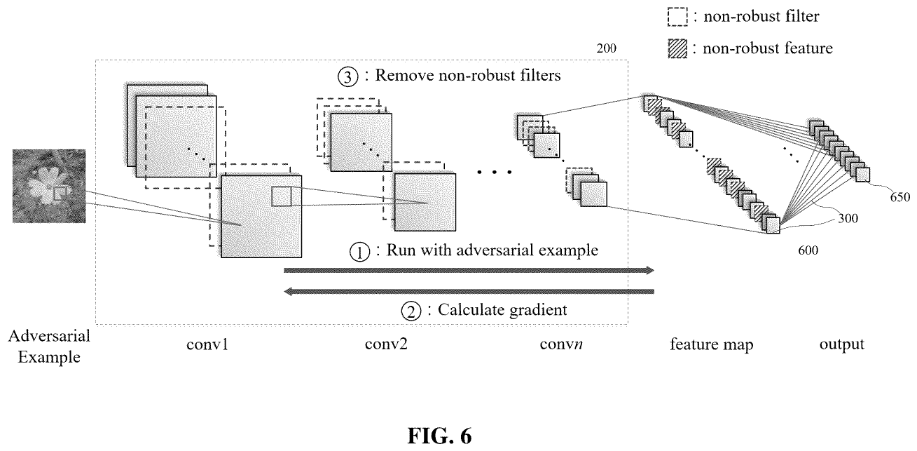

FIG. 6 is a diagram illustrating the concept of filter pruning according to an embodiment of the present invention.

Referring to FIG. 6, the convolutional neural network 200 includes a plurality of filters for each layer, and final feature maps 600 in the convolutional neural network 200 are generated by a convolution operation using each filter.

The final feature maps 600 output from the convolutional neural network 200 are input to the FC neural network 300, and feature values 650 are output through the FC neural network 300. A gradient based on a loss between the feature values and a label is propagated to the FC neural network 300 and the convolutional neural network 200.

In FIG. 6, the filters indicated by red dotted lines are filters whose loss gradient size is greater than or equal to a threshold value and are filters that are removed by the filter pruning unit 420. In addition, among the final feature maps 600 shown in FIG. 6, the feature maps indicated with red dotted lines are feature maps that are no longer generated when filter pruning is completed.

In other words, as the filters of each convolutional layer are removed by filter pruning, the number of feature maps output from each layer also decreases.

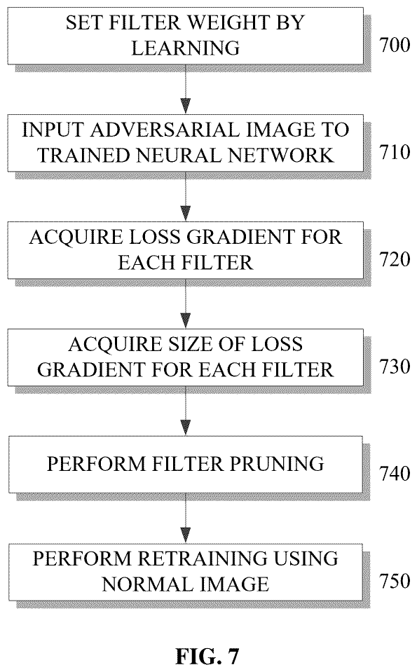

FIG. 7 is a flowchart illustrating the overall flow of a training method for responding to image adversarial attacks according to an embodiment of the present invention.

Referring to FIG. 7, in operation 700, first, the convolutional neural network 200 and the FC neural network 300 are trained using a normal image to set filter weights for the convolutional neural network 200.

When the filter weights are set through learning about the normal image, an image damaged by the adversarial attack is input to the trained convolutional neural network 200 in operation 710.

Feature maps for the image damaged by the adversarial attack input to the convolutional neural network 200 are output through a convolution operation of the convolutional neural network 200, and the feature maps are input to the trained FC neural network 300. Based on a loss between the feature values output from the FC neural network 300 and the label, a loss gradient is acquired for each filter of the convolutional neural network in operation 720.

When the loss gradient for each filter is acquired, the size of the loss gradient for each filter is acquired in operation 730. As previously described, the size of the gradient for each filter may be acquired through an L2 norm operation of the loss gradients propagated to the filter.

Filter pruning is performed based on the size of the loss gradient for each filter in operation 740. As described previously, whether the filter is pruned is determined by comparing the size of the loss gradient of a specific filter with a threshold value.

When filter pruning of the convolutional neural network is completed, the convolutional neural network modified through filter pruning is retrained using the normal image in operation 750.

The method according to the exemplary embodiment of the present invention can be implemented as a computer program that is stored in a medium and executed in a computer. A computer-readable recording medium may be any medium to be accessed by a computer system and include all computer storage media. Here, the computer storage media may include a read only memory (ROM), a random access memory (RAM), a compact disc (CD)-ROM, a digital video disk (DVD)-ROM, magnetic tape, a floppy disk, an optical data storage, etc.

The present invention has been described with reference to exemplary embodiments illustrated in the drawing, but the exemplary embodiments are only illustrative, and it should be understood by those skilled in the art that various modifications and equivalent exemplary embodiments are possible therefrom.

Accordingly, the actual scope of the present invention should be determined by the spirit of the appended claims.

1. An image training device that is robust to an image adversarial attack, the image training device comprising:
a normal image training unit configured to set weights of a convolutional neural network and a fully connected (FC) neural network through learning about a normal image;
an adversarial image gradient acquisition unit configured to input an image damaged by an adversarial attack into the trained convolutional neural network and acquire a loss gradient size caused by the image damaged by the adversarial attack for each filter of the convolutional neural network;
a filter pruning unit configured to prune some filters of the convolutional neural network based on the loss gradient size for each filter; and
a retraining unit configured to retrain a convolutional neural network and a FC neural network modified through the filter pruning using the normal image.

2. The image training device of claim 1, wherein the adversarial image gradient acquisition unit includes:
a loss gradient calculation unit configured to input the image damaged by the adversarial attack to calculate loss gradients generated by backpropagating a loss between a feature value output from the FC neural network and a correct answer label; and
a gradient size acquisition unit for each filter configured to acquire loss gradients for each filter of the convolution neural network and acquire sizes of the acquired loss gradients for each filter.

3. The image training device of claim 2, wherein the gradient size acquisition unit for each filter acquires gradient sizes for each filter by calculating an L2 norm of the gradients for each filter.

4. The image training device of claim 2, wherein the filter pruning unit prunes filters whose gradient sizes are greater than or equal to a threshold value.

5. The image training device of claim 4, wherein the threshold value is set adaptively based on the gradient sizes of the filters.

6. The image training device of claim 2, wherein the retraining unit resets weights of the modified convolutional neural network by comparing feature values output through the modified convolutional neural network and the FC neural network with the correct answer label.

7. An image training method that is robust to an image adversarial attack, the image training method comprising operations of:
(a) setting weights of a convolution neural network and a FC neural network through learning about a normal image;
(b) inputting an image damaged by an adversarial attack into the trained convolutional neural network and acquiring a loss gradient size caused by the image damaged by the adversarial attack for each filter of the convolutional neural network;
(c) pruning some filters of the convolutional neural network based on the loss gradient size for each filter; and
(d) retraining a convolutional neural network and a FC neural network modified through the operation (c).

8. The image training method of claim 7, wherein the operation (b) includes:
inputting the image damaged by the adversarial attack to calculate loss gradients generated by backpropagating a loss between a feature value output from the FC neural network and a correct answer label; and
acquiring loss gradients for each filter of the convolution neural network, and acquiring sizes of the acquired loss gradients for each filter.

9. The image training method of claim 8, wherein the acquiring of the sizes of the loss gradients for each filter includes acquiring the gradient sizes for each filter by calculating an L2 norm of the gradients for each filter.

10. The image training method of claim 8, wherein the operation (c) of pruning some of the filters includes pruning filters whose gradient sizes are greater than or equal to a threshold value.

11. The image training method of claim 8, wherein the operation (c) of pruning some of the filters includes pruning filters whose gradient sizes are greater than or equal to a threshold value.

12. The image training method of claim 8, wherein the operation (d) of retraining the convolutional neural network includes resetting weights of the modified convolutional neural network by comparing feature values output through the modified convolutional neural network and the PC neural network with the correct answer label.
